(19) United States
(12) Patent Application Publication
(10) Pub. No.: US 2024/0343296 A1
(43) Pub. Date: Oct. 17, 2024

(54) VEHICLE CONTROL INCLUDING ESTIMATING TORQUE FROM STEERING OPERATIONS

(71) Applicant: Ford Global Technologies, LLC, Dearborn, MI (US)

(72) Inventors: Akshay Bhardwaj, Ann Arbor, MI (US); Quazi Mohammed Rushaed Farooqi, Troy, MI (US); Steven R. El Aile, Sterling Heights, MI (US)

(73) Assignee: Ford Global Technologies, LLC, Dearborn, MI (US)

(21) Appl. No.: 18/300,591

(22) Filed: Apr. 14, 2023

(51) Int. Cl. B62D 5/04

(52) U.S. Cl. CPC B62D 5/0463

(57) ABSTRACT

A system can include computer including a processor and memory, the memory storing instructions executable by the processor to compute an estimate of frictional torque responsive to receipt of an input signal representing a measurement of an angular velocity of a steering motor, compute an estimate of operator torque applied to an element of a steering subsystem based on the computed estimate of the frictional torque and to actuate a component in a vehicle in response to the computed estimate exceeding a threshold value.

### BACKGROUND

A torque sensor can be utilized in a vehicle steering system to assist in determining an amount of torque applied to a steering wheel, e.g., by an operator's hand and/or due to some other source.

### BRIEF DESCRIPTION OF THE DRAWINGS

FIG. 1 is a block diagram of an example vehicle.

FIG. 2 is a diagram showing steering components of a vehicle.

FIG. 3 is a block diagram showing input signals utilized in estimating torque from steering operations of a vehicle.

FIG. 4 is a process flow diagram illustrating an example process for estimating operator torque applied to a steering element.

### DETAILED DESCRIPTION

This disclosure provides techniques for vehicle operation that include estimating torque applied by an operator to a steering wheel, such as during steering operations. In examples, a torque sensor mounted near the steering rack of a vehicle measures torque (e.g., torsion) in response to an operator of the vehicle placing one or more hands on the steering wheel of the vehicle. Output signals from the torque sensor are then combined with frictional torque applied by various mechanical components of the vehicle steering system. The frictional torque applied by the various mechanical components of the vehicle steering system can be modeled, such as by way of a state space model, which explicitly characterizes the frictional torque as a function of, for example, the current angular velocity of a steering motor. The modeled frictional torque, along with measurements representing the torque applied by an operator of the vehicle, can be input to an optimal filter, which can operate to adaptively extract estimates of torque applied by the operator of the vehicle in the presence of interfering signals, such as signals representing frictional torque, of the steering system. Thus, advantageously, estimated torque measurements, which more closely represent torque that is in response to an operator's hand positioned on the steering wheel, can be input to an assisted driving application. In turn, the assisted driving application can utilize programming steps that can result in actuation of a vehicle component. In an example, in response to an estimation indicating that an operator's hands have been removed from contact with the steering wheel, the assisted driving application can generate a message to notify the operator to place one or more hands into contact with the steering wheel. In another example, in response to an estimation that an operator's hands are presently in contact with the steering wheel, the assisted driving application can maintain the current assisted driving mode.

An example system can include a computer having a processor and memory, the memory storing instructions executable by the processor to compute an estimate of frictional torque responsive to receipt of an input signal representing a measurement of an angular velocity of a steering motor, to compute an estimate of operator torque applied to an element of a steering subsystem based on the computed estimate of the frictional torque, and to actuate a component in a vehicle in response to the computed estimate exceeding a threshold value.

The threshold value can indicate removal of the operator's hand from the steering element.

The executable instructions can further include instructions to combine a linearized estimate of frictional torque as a function of the angular velocity of the steering motor with a measure of bristle deflection resulting from contact of a gear of the steering motor with a rack of the steering subsystem.

The executable instructions can further include instructions to combine a linearized estimate of frictional torque as a function of the angular velocity of the steering motor with a measure of bristle deflection resulting from contact of a gear of the steering motor with a rack of the steering subsystem and a measure of stiffness and damping of a friction model of a steering subsystem of the vehicle.

The executable instructions can further include instructions to combine a linearized estimate of frictional torque as a function of the angular velocity of the steering motor with a measure of bristle deflection resulting from contact of a gear of the steering motor with a rack of the steering subsystem and a measure of stiffness and damping of a LuGre friction model of a steering subsystem of the vehicle.

The executable instructions can include instructions to compute the estimate of operator torque utilizing an optimal filter.

The executable instructions can include instructions to compute the estimate of operator torque utilizing a Kalman filter or a particle filter.

The component can be a component of a human machine interface (HMI) of the vehicle.

The instructions to actuate the component of the vehicle can include instructions to transition an assisted driving application from an autonomous driving mode to a semi-autonomous driving mode or from a semi-autonomous driving mode to a manual driving mode.

The system can further include a torque sensor to provide a measure of the operator torque applied to the steering element, the torque sensor located proximate to an interface between a rack and a pinion gear of a steering subsystem.

An example method can include computing an estimate of frictional torque responsive to measuring an angular velocity of a steering motor, computing an estimate of operator torque applied to an element of a steering subsystem based on the computed estimate of the frictional torque, and actuating a component in a vehicle in response to the computed estimate exceeding a threshold value.

The threshold value can indicate removal of the operator's hand from the steering element.

The method can additionally include combining a linearized estimate of frictional torque as a function of the angular velocity of the steering motor with a measure of bristle deflection resulting from contact of a gear of the steering motor with a rack of the steering subsystem.

The method can additionally include combining a linearized estimate of frictional torque as a function of the angular velocity of the steering motor with a measure of bristle deflection resulting from contact of a gear of the steering motor with a rack of the steering subsystem and a measure of stiffness and damping of a friction model of a steering subsystem of the vehicle.

The method can additionally include combining a linearized estimate of frictional torque as a function of the angular velocity of the steering motor with a measure of bristle deflection resulting from contact of a gear of the steering motor with a rack of the steering subsystem and a measure of stiffness and damping of a LuGre friction model of a steering subsystem of the vehicle.

The method can additionally include computing an estimate of the operator torque utilizing an optimal filter.

The method can additionally include computing an estimate operator torque utilizing a Kalman filter or a particle filter.

The component can be a component of a human machine interface (HMI) of the vehicle.

Actuating a component of the vehicle can include transitioning an assisted driving application from an autonomous driving mode to a semi-autonomous driving mode.

The method can additionally include receiving a signal from a torque sensor representing a measure of the operator torque applied to the steering element, the torque sensor located proximate to an interface between a rack and a pinion gear of a steering subsystem.

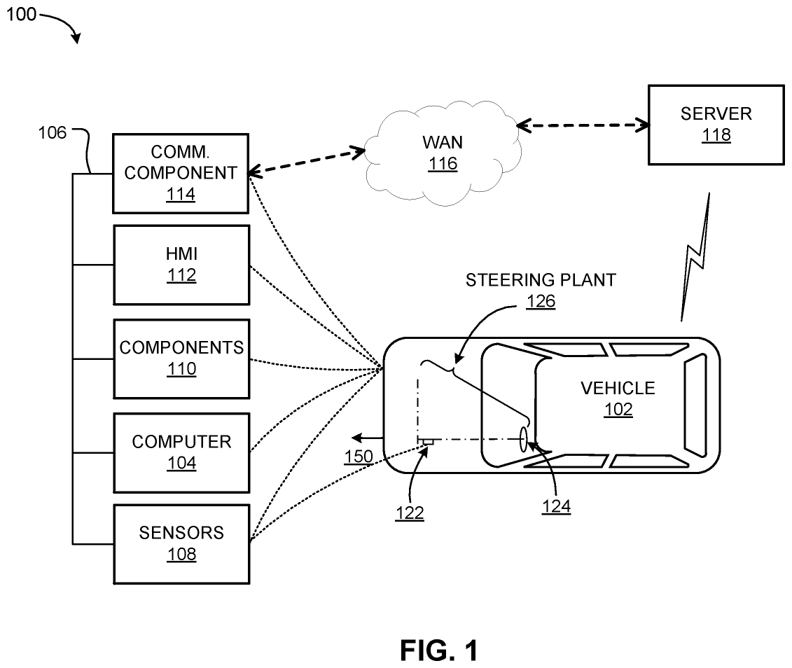

FIG. 1 is a block diagram of an example vehicle. As shown in FIG. 1, system 100 includes vehicle 102, that includes computer 104, which is communicatively coupled, via vehicle network 106, to various elements including sensors 108, subsystems or components 110, such as steering, propulsion, braking, human machine interface (HMI) 112, and communication component 114. Computer 104, and server 118 discussed below, include a processor and a memory. A memory of computer 104, such as those described herein, includes one or more forms of non-transitory media readable by computer 104, and can store instructions executable by computer 104 for performing various operations, such that the vehicle computer is configured to perform the various operations, including those disclosed herein.

For example, computer 104 can include a generic computer with a processor and memory as described above and/or may comprise an electronic control unit (ECU) or a controller for a specific function or set of functions, and/or a dedicated electronic circuit including an ASIC (application specific integrated circuit) that is manufactured for a particular operation, (e.g., an ASIC for processing data from sensors and/or communicating data from sensors 108). In another example, computer 104 may include an FPGA (Field-Programmable Gate Array), which is an integrated circuit manufactured to be configurable by a user. In example embodiments, a hardware description language such as VHDL (Very High Speed Integrated Circuit Hardware Description Language) may be used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected or coupled to the FPGA circuit.) In some examples, a combination of processor(s), ASIC(s), and/or FPGA circuits may be included in computer 104. Further, computer 104 may include a plurality of computers in the vehicle (e.g., a plurality of ECUs or the like) operating together to perform operations ascribed herein to the computer 104.

A memory of computer 104 can include any type, such as hard disk drives, solid state drives, or any other volatile or non-volatile media. The memory can store the collected data transmitted by sensors 108. The memory can be a separate device from computer 104, and computer 104 can retrieve information stored by the memory via a communication network in the vehicle such as vehicle network 106, e.g., over a controller area network (CAN) bus, a local interconnect network (LIN) bus, a wireless network, etc. Alternatively or additionally, the memory can be part of computer 104, for example, as a memory internal to computer 104.

Computer 104 can include or access instructions to operate one or more components 110 such as vehicle brakes, propulsion (e.g., one or more of an internal combustion engine, electric motor, hybrid engine, etc.), steering, climate control, interior and/or exterior lights, infotainment, navigation etc., as well as to determine whether and when computer 104, as opposed to a human operator, is to control such operations. Computer 104 can include or be communicatively coupled, e.g., via vehicle network 106, to more than one processor, which can be included in components 110 such as sensors 108, electronic control units (ECUs) or the like included in the vehicle for monitoring and/or controlling various vehicle components, e.g., a powertrain controller, a brake controller, a steering controller, etc.

Vehicle sensors 108 can further include torque sensor 122, which can be any suitable torque sensor that operates to measure torque (i.e., torsion) applied to a steering element, e.g., steering wheel 124, as an operator applies a rotational force to the steering wheel to control the heading of vehicle 102. In an example, torque sensor 122 is mounted to steering plant 126 to measure torque in the range of 0.02 Newton meters (N-m) to 2.0 N-m. Torque sensor 122 can include a calibrated strain gauge, for example, to provide a voltage signal that is proportional to torque applied to steering wheel 124. In an example, torque sensor 122 is capable of measuring torque at all times, or at virtually all times, that an operator steers vehicle 102 with at least one hand in contact with steering wheel 124 as vehicle 102 proceeds along path 150. In response to an operator removing their hands from steering wheel 124, torque sensor 122 may measure a small amount of torque, such as in response to frictional torques, which act on steering plant 126.

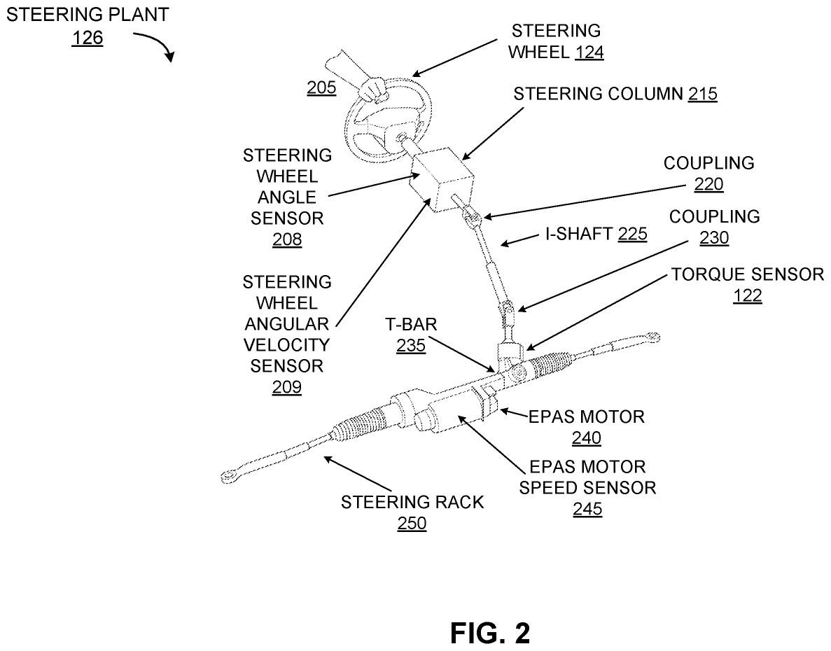

As used herein, a “steering plant,” which is described in greater detail in reference to FIG. 2, means a set of mechanical and/or electromechanical components utilized to steer vehicle 102. Accordingly, for example, steering plant 126 can include steering wheel 124, as well as a steering column connected to steering wheel 124. Steering plant 126 can also include an electronic power assistance steering (EPAS) motor that operates to amplify and/or augment torque transmitted from steering wheel 124 to a pinion gear positioned on a steering rack of vehicle 102. Steering plant 126 can further include bushings, seals, fluid couplings, steering rods, steering dampers, etc., which assist in controlling the heading of vehicle 102 as the vehicle moves along path 150.

Torque sensor 122, which can be located proximate to an interface between a rack and a pinion gear of a steering subsystem of vehicle 102 (described in greater detail in reference to FIG. 2) may be susceptible to various sources that affect measuring torque responsive to an operator applying torque to steering wheel 124. For example, inaccuracies or noise can be introduced by friction between components of steering plant 126 of vehicle 102. Such noise may be characterized as frictional torque, which, as used herein, means torque caused or introduced by one or more frictional forces occurring between or among static or moving objects of steering plant 126. Accordingly, frictional torque may occur in response to static or dynamic friction between a pinion gear and a rack of steering plant 126, friction between or among adjacent components of universal joints of steering plant 126, as well as between steering rods, steering dampers, bushings, seals and other components of steering plant 126 as well as mechanical interfaces between components of steering plant 126 and vehicle 102. Thus, measuring torque applied by an operator of vehicle 102 may involve use of one or more optimal filters, such as an averaging filter, a Kalman filter, a particle filter, etc., which can operate to adaptively extract estimates of torque applied by the operator in the presence of noise signals, such as signals representative of frictional torque between or among components of steering plant 126.

It is noted that although FIG. 1 shows a steering wheel, techniques described herein can apply to steering elements other than a steering wheel of a vehicle, such as a joystick, an aircraft control yoke, etc.

Computer 104 may be generally arranged for communications on vehicle network 106 that can include a communications bus in the vehicle, such as a controller area network CAN or the like, and/or other wired and/or wireless mechanisms. Vehicle network 106 corresponds to a communications network, which can facilitate exchange of messages between various onboard vehicle devices, e.g., sensors 108, components 110, computer 104. Computer 104 can be generally programmed to send and/or receive, via vehicle network 106, messages to and/or from other devices of vehicle 102, e.g., any or all of ECUs, sensors 108, actuators, components 110, communications component 114, human machine interface (HMI) 112. For example, various component 110 subsystems (e.g., components 110) can be controlled by respective ECUs.

Further, in implementations in which computer 104 actually comprises a plurality of devices, vehicle network 106 may be used for communications between devices represented as computer 104 in this disclosure. For example, vehicle network 106 can provide a communications capability via a wired bus, such as a CAN bus, a LIN bus, or can utilize any type of wireless communications capability. Vehicle network 106 can include a network in which messages are conveyed using any other wired communication technologies and/or wireless communication technologies, e.g., Ethernet, Wi-Fi®, Bluetooth®, etc. Additional examples of protocols that may be used for communications over vehicle network 106 in some implementations include, without limitation, Media Oriented System Transport (MOST), Time-Triggered Protocol (TTP), and FlexRay. In some implementations, vehicle network 106 can represent a combination of multiple networks, possibly of different types, that support communications among devices onboard a vehicle. For example, vehicle network 106 can include a CAN bus, in which some in-vehicle sensors and/or components communicate via a CAN bus, and a wired or wireless local area network in which some device in vehicle communicate according to Ethernet, Wi-Fi®, and/or Bluetooth communication protocols.

Vehicle 102 typically includes a variety of sensors 108 in addition to torque sensor 122 positioned on steering plant 126. Sensors 108 can include a suite of devices that can obtain one or more measurements of one or more physical phenomena. Some of sensors 108 detect variables that characterize the operational environment of the vehicle, such as vehicle speed (e.g. from vehicle wheel speed sensors), vehicle towing parameters, vehicle braking parameters, engine torque output, engine and transmission temperatures, battery temperatures, vehicle steering angles, etc. Some of sensors 108 detect variables that characterize the physical environment of vehicle 102, such as ambient air temperature, humidity, weather conditions (e.g., rain, snow, etc.), parameters related to the inclination or gradient of a road or other type of path on which the vehicle is proceeding, etc. In example embodiments, sensors 108 can operate to detect the position or orientation of the vehicle utilizing, for example, signals from a satellite positioning system (e.g., the global positioning system or GPS); accelerometers, such as piezo-electric or microelectromechanical systems MEMS; gyroscopes such as rate, ring laser, or fiber-optic gyroscopes; inertial measurement units IMU; and magnetometers. In example embodiments, sensors 108 can include sensors to detect aspects of the environment external to vehicle 102, such as radar sensors, scanning laser range finders, cameras, etc. Sensors 108 can also include light detection and ranging (LIDAR) sensors, which operate to detect distances to objects by emitting a laser pulse and measuring the time of flight for the pulse to travel to the object and back. Sensors 108 may include a controller and/or a microprocessor, which executes instructions to perform, for example, analog-to-digital conversion to convert sensed analog measurements and/or observations to input signals that can be provided to computer 104, e.g., via vehicle network 106.

Computer 104 can be configured for utilizing vehicle-to-vehicle (V2V) communications via communication component 114 and/or may interface with devices outside of the vehicle, e.g., through wide area network (WAN) 116 via V2V communications. Computer 104 can communicate outside of vehicle 102, such as via vehicle-to-infrastructure (V2I) communications, vehicle-to-everything (V2X) communications, or V2X including cellular communications C-V2X, and/or wireless communications cellular dedicated short range communications DSRC, etc. Communications outside of vehicle 102 can be facilitated by direct radio frequency communications and/or via network server 118. Communications component 114 can include one or more mechanisms by which computer 104 communicates with vehicles outside of vehicle 102, including any desired combination of wireless, e.g., cellular, wireless, satellite, microwave, radio frequency communication mechanisms and any desired network topology or topologies when a plurality of communication mechanisms are utilized.

Vehicle 102 can include HMI 112 (human-machine interface), e.g., one or more of an infotainment display, a touchscreen display, a microphone, a speaker, a haptic device, etc. A user, such as the operator of vehicle 102, can provide input to devices such as computer 104 via HMI 112. HMI 112 can communicate with computer 104 via vehicle network 106, e.g., HMI 112 can send a message including the user input provided via a touchscreen, microphone, a camera that captures a gesture, etc., to computer 104, and/or can display output, e.g., via a display, speaker, etc. Further, operations of HMI 112 can be performed by a portable user device (not shown) such as a smart phone or the like in communication with computer 104, e.g., via Bluetooth or the like.

WAN 116 can include one or more mechanisms by which computer 104 may communicate with server 118. Server 118 can include an apparatus having one or more computing devices, e.g., having respective processors and memories and/or associated data stores, which may be accessible via WAN 116. In example embodiments, vehicle 102 could include a wireless transceiver (i.e., transmitter and/or receiver) to send and receive messages outside of vehicle 102. Accordingly, the network can include one or more of various wired or wireless communication mechanisms, including any desired combination of wired e.g., cable and fiber and/or wireless, e.g., cellular, wireless, satellite, microwave, and radio frequency communication mechanisms and any desired network topology or topologies when multiple communication mechanisms are utilized. Exemplary communication networks include wireless communication networks, e.g., using Bluetooth, Bluetooth Low Energy BLE, IEEE 802.11, V2V or V2X such as cellular V2X CV2X, DSRC, etc., local area networks and/or wide area networks 116, including the Internet.

In an example implementation, torque sensor 122 measures an overall or total torque to which a steering wheel 124 is subjected, which can include torque applied by an operator seated at a driver's position of vehicle 102. Overall torque measured by torque sensor 122 can include parasitic or frictional torque contributions, such as those applied by static and dynamic components of steering plant 126, which operate to reduce the accuracy of a measurement of torque applied by the operator of vehicle 102. An optimal filter, such as an averaging filter, a Kalman filter, a particle filter, etc., can operate to extract the contribution of the torque applied by the operator of vehicle 102 from the overall torque measured by torque sensor 122. To characterize frictional torque generated within steering plant 126, computer 104 can obtain input signals representing parameters of steering plant 126, such as the angular velocity of EPAS motor 240, an angular orientation of steering wheel 124, as well as an angular velocity of the steering wheel. These signals, along with other characterizations of mechanical components and interfaces of steering plant 126, can be input to a state space representation utilized to model frictional and other components that represent sources of inaccuracy in computing torque applied by an operator of vehicle 102. The state space model representation can then be used in an optimal filtering process, which operates to estimate the portion of the overall torque that is attributed to an operator of vehicle 102 having one or more hands in contact with steering wheel 124. Responsive to estimating the torque contribution from one or more hands of the operator being above a threshold, so as to indicate that the operator of vehicle 102 has one or more hands in contact with steering wheel 124, a vehicle assisted driving application can operate in a mode suitable for vehicle operation while the operator's hands are in contact with the steering wheel. Responsive to estimating the torque contribution from one or more hands of the operator being below a threshold, so as to indicate removal of the operator's hands from steering wheel 124, a vehicle assisted driving application can operate in a mode suitable for vehicle operation while the operator's hands are not in contact with the steering wheel. Such operation can include actuating a propulsion component of vehicle 102, providing a notification to the operator, etc.

### Exemplary System Operations

FIG. 2 is a diagram showing steering components of an example steering plant 126 for a vehicle 102. Steering plant 126 includes steering wheel 124, upon which operator 205 of vehicle 102 has placed a hand, so as to control the heading of vehicle 102. Steering wheel 124 may be coupled to steering column 215, which may include components to control, for example, windshield wipers, turn signals, ignition, and other vehicle functions. Steering column 215 additionally includes steering wheel angle sensor 208 and steering wheel angular velocity sensor 209, which operate to measure an angle of orientation and an angular velocity of steering wheel 124. Steering wheel 124 and steering column 215 are shown as being coupled to I-shaft 225 via coupling 220, which may include, for example, a universal joint. I-shaft 225 utilizes coupling 230 to transmit torque applied by operator's hand 205 to torsion bar 235 (T-bar 235 in FIG. 2), and to EPAS motor 240. EPAS motor 240 can operate to amplify and/or augment torque applied to steering wheel 124 so as to actuate steering rack 250, thus controlling the heading of vehicle 102. In an example, measurements of EPAS motor speed from EPAS motor speed sensor 245, torque measurements from torque sensor 122, steering wheel angle and steering wheel angular velocity from steering column 215 are transmitted to computer 104 via vehicle network 106.

In another example steering plant, steering wheel angle sensor 208 and steering wheel angular velocity sensor 209 may be positioned at locations other than steering column 215. In such an example, actions performed by steering wheel angle sensor 208 and steering wheel angular velocity sensor 209 may be performed by EPAS motor speed sensor 245. In another example, measurements performed by steering wheel angle sensor 208 and steering wheel angular velocity sensor 209 may be performed indirectly via measurements derived from EPAS motor speed sensor 245.

As seen in FIG. 2, torque sensor 122 is positioned between coupling 230 and T-bar 235. Accordingly, torque applied by operator 205 travels through steering column 215, through coupling 220, I-shaft 225, and through coupling 230, prior to being measured via torque sensor 122. Thus, responsive to temporary elastic deformation of steering column 215 and I-shaft 225, as well as friction introduced by couplings 220 and 230, torque applied at steering wheel 124 may differ significantly from torque measured by torque sensor 122. In addition, torque applied by EPAS motor 240, which may involve the use of a toothed-gear that contacts a serrated surface of steering rack 250 can introduce further inaccuracies in determining operator-applied torque measured at torque sensor 122.

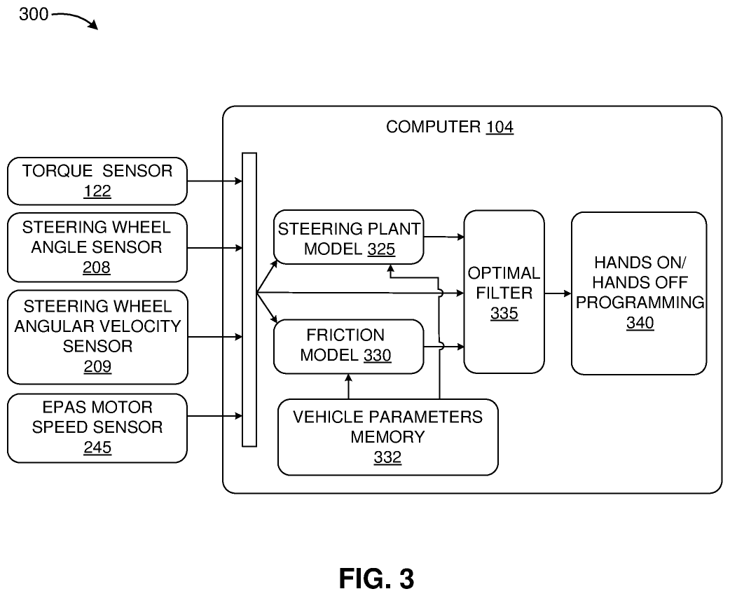

FIG. 3 is a block diagram 300 showing input signals and operations involved in estimating torque from steering operations of vehicle 102. As seen in FIG. 3, measurements from torque sensor 122, steering wheel angle sensor 208, steering wheel angular velocity sensor 209, and EPAS motor speed sensor 245 are utilized by friction model 330 and steering plant model 325 in a process of estimating torque from steering operations of vehicle 102. Friction model 330 and steering plant model 325 may be implemented in programming steps executed by computer 104. Outputs of models 325 and 330 may be utilized by optimal filter 335, which can include an averaging filter, a Kalman filter, a particle filter, etc. Optimal filter 335 can extract estimates of torque applied by operator 205 for input to hands-on/hands-off programming 340, which can determine whether an estimate of torque applied by operator 205 exceeds a minimum torque threshold of an operator hands-on condition. In response to estimated torque applied by operator 205 exceeding a predetermined threshold, the vehicle assisted driving application can operate in a mode suitable for vehicle operation while the operator's hands are in contact with the steering wheel. Responsive to an estimated torque contribution from one or more hands of the operator being below a threshold, which may indicate removal of the operator's hands from steering wheel 124, a vehicle assisted driving application can operate in a mode suitable for vehicle operation while the operator's hands are not in contact with the steering wheel.

In an example, friction model 330 is computed in accordance with expression (1), (2), and (3) below, in which T_{fs} represents a speed-dependent nonlinear static friction function that can be linearized to estimate the frictional torque of steering plant 126. As seen in expression (1) friction model 330 is expressed as a function of EPAS motor speed, speed of vehicle 102, the steering angle of vehicle 102, and various vehicle-dependent constants stored in vehicle parameters memory 332. As described in reference to FIG. 2, EPAS motor speed Corot can be obtained from EPAS motor speed sensor 245. An estimation of force applied to steering rack 250, F, in expression (1), can be computed via expressions (2) and (3) which follow the description of expression (1).

$${T}_{fs} = ( {ω}_{rot} , {F}_{r} ) = \{ \begin{matrix}{k}_{0}^{+} + {k}_{ω}^{+} \vert {ω}_{rot} \vert + {k}_{r}^{+} \vert {F}_{r} \vert for v \geq 0 \\ {k}_{0}^{-} + {k}_{ω}^{-} \vert {ω}_{rot} \vert + {k}_{r}^{-} \vert {F}_{r} \vert for v \leq 0\end{matrix} \qquad ( 1 )$$

wherein the offset levels are given by k₀⁺ and k₀⁻, the steering system load gain are given by kᵣ⁺ and k_{y}⁻, and the viscous damping coefficients are given by k_{ω}⁺ and k_{ω}⁻. In addition, ωᵣₒₜ corresponds to the angular velocity (in radians/sec) as measured by EPAS motor speed sensor 245. Approximations for the above identified parameters k₀⁺, k_{ω}⁺, kᵣ⁺, k₀⁻, k_{ω}⁻, and kᵣ⁻, provided in Table I, below, can be stored in vehicle parameters memory 332.

TABLE I

| Parameter | Value | Units |
|---|---|---|
| k⁺₀ | 5.6 × 10⁻² | Nm |
| k⁺_{ω} | 1.258 × 10⁻¹ | Nm |
| k⁺ᵣ | 4.195 × 10⁻⁴ | Nm/s |
| k⁻₀ | 6.658 × 10⁻⁵ | Nm/s |
| k⁻_{ω} | 4.993 × 10⁻⁵ | Nm/N |
| k⁻ᵣ | 4.345 × 10⁻⁵ | Nm/N |

Further, the force applied to steering rack 250 (Fr) of expression (1) is computed in accordance with expression (2), below:

$${F}_{r} = {k}_{1} {a}_{y , Ref} + {k}_{2} {α}_{f} \qquad ( 2 )$$

wherein k₁ and k₂ represent tuning factors based on tires of vehicle 102, which can be stored in vehicle parameters memory 332 of computer 104. α_{f} represents a front tire side slip angle derived from rear cornering stiffness of vehicle 102 stored in vehicle parameters memory 332 of computer 104. α_{y,Ref} is given by expression (3), below:

$${a}_{y , Ref} = \frac{{v}_{x}^{2} δ}{l \cdot ( 1 + \frac{{v}_{x}^{2}}{{v}_{ch}^{2}} )} \qquad ( 3 )$$

In expression (3), l represents the vehicle wheelbase stored in vehicle parameters memory 332, vₓ represents the speed of vehicle 102 from sensors 108, δ represents the steering angle of vehicle 102 from sensors 108, and v_{ch} represents a characteristic calibration value of vehicle 102 stored in vehicle parameters memory 332.

In an example that accords with the LuGre friction model, described by Olsson, H., Astroem, K., de Wit, C. C., Graefvert, M., and Lischinsky, P., 1998, “Friction Models and Friction Compensation,” European Journal of Control, 4(3), pp. 176-195) and in accordance with Astroem, K., and deWit, C. C., 2008, “Revisiting the LuGre model,” IEEE Control Systems Magazine, 28(6), pp. 101-114, expressions (4) and (5), below, can be utilized to estimate the contribution of frictional torque from steering plant 126.

$$\dot{z} = {ω}_{rot} - \frac{\vert {ω}_{rot} \vert}{{T}_{f s}} {σ}_{0} z \qquad ( 4 )$$

wherein expression (4) represents a differential equation for computing the intermediate variable ż, utilized in expression (5) below. ωᵣₒₜ of expression (4) represents ωᵣₒₜ of expression (1), which can be obtained from EPAS motor speed sensor 245. T_{fs} represents the general speed-dependent nonlinear static friction function that can be linearized to represent the frictional torque of steering plant 126, of expression (1). σ₀ of expression (4) represents a deflection parameter of the bristles of the contact surface between the pinion gear and the serrated surface of steering rack 250 of FIG. 2. In this context, bristle deflection means the average deflection of the teeth of the pinion gear as the pinion gear contacts the serrated surface of steering rack 250. In an example, the average bristle deflection is determined by the slip velocity. Thus, as the slip velocity increases, the number of bristles of the pinion gear in contact with steering rack 250 decreases. Accordingly, the value of the friction force between both bodies decreases along with an increasing slip velocity.

Expression (4), which solves for the intermediate variable ż, can be utilized in expression (5) to explicitly characterize frictional torque in a state-space model of steering plant 126.

$${T}_{f} = {σ}_{0} z + {σ}_{1} \dot{z} \qquad ( 5 )$$

wherein ż is computed via the differential equation of expression (4), σ₀ of expression (5) represents a bristle stiffness parameter of the contact surface between the pinion gear and the serrated surface of steering rack 250, and wherein σ₁ represents the damping constant of the contact surface between the pinion gear and the serrated surface of steering rack 250. The constants σ₀ and σ₁ can be obtained from vehicle parameters memory 332 of computer 104.

Based on the explicit model for T_{f} of from expressions (1)-(5) a state space model of Newton's second law is provided in expression (6), below, which in this context, expresses angular acceleration in proportion to the net torque (T_{f}+T_{d}) measured via torque sensor 122.

$${J}_{sw} {\ddot{θ}}_{sw} = k ( {θ}_{p} - {θ}_{sw} ) + {c}_{c} ( {\dot{θ}}_{p} - {\dot{θ}}_{sw} ) - {c}_{sw} {\dot{θ}}_{sw} + {T}_{f} + {T}_{d} \qquad ( 6 )$$

wherein J_{sw} corresponds to the moment of inertia of the steering wheel, which can be obtained from vehicle parameters memory 332. \ddot{θ}_{sw} represents the second derivative of the steering wheel angle, which can be computed by the computer 104 responsive to differentiating the steering wheel angular velocity obtained from steering wheel angular velocity sensor 209. k represents an effective stiffness of steering plant 126, obtained from vehicle parameters memory 332. θₚ represents a pinion angle obtained via integration of output signals from EPAS motor speed sensor 245. θ_{sw} represents the angle of steering wheel 124 obtained from steering wheel angle sensor 208 positioned at steering column 215 or derived from measurements performed by EPAS motor speed sensor 245. c_{c} represents the viscous damping coefficient of steering plant 126, obtained from vehicle parameters memory 332. \dot{θ}ₚ represents the angular velocity of steering wheel 124 obtained from steering wheel angle sensor 208. θ_{sw} represents the steering wheel angular velocity obtained from steering wheel angular velocity sensor 209 positioned at steering column 215 or derived from measurements performed by EPAS motor speed sensor 245. c_{sw} represents the coefficient of friction of steering wheel 124 obtained from vehicle parameters memory 332. T_{f} represents frictional torque obtained from expression (5). T_{d} represents torque applied by operator 205.

Expression (6) can be rearranged into the standard state space notation having a general form of expressions (7A) and (7B) below:

$$\dot{x} ( t ) = [ A ] x ( t ) + [ B ] u ( t ) \qquad ( 7 A )$$

$$y ( t ) = [ C ] x ( t ) + [ D ] u ( t ) \qquad ( 7 B )$$

wherein [A] represents the system matrix, [B] represents the input matrix, [C] represents the output matrix, [D] represents the feedthrough matrix, x(t) represents the state vector as a function of time, u(t) represents the input vector, and y(t) represents the output vector. Thus, rearranging expression (6) to accord with the state space notation of expressions (7A) and (7B) results in expressions (8) and (9) below:

$$( 8 )$$

$$[ \text{} \begin{matrix}{\dot{x}}_{1} \\ {\dot{x}}_{2} \\ {\dot{T}}_{d}\end{matrix} ] = [ \begin{matrix}0 & 1 & 0 \\ - \frac{k}{{J}_{sw}} & - \frac{{c}_{c} + {c}_{sw}}{{J}_{sw}} & \frac{1}{{J}_{sw}} \\ 0 & 0 & 0\end{matrix} ] [ \text{} \begin{matrix}{x}_{1} \\ {x}_{2} \\ {T}_{d}\end{matrix} ] + [ \frac{k}{{J}_{sw}} - \text{} \begin{matrix}\frac{{c}_{c}}{{J}_{sw}} & 0 \\ \frac{{c}_{c} ( {c}_{c} + {c}_{sw} )}{{J}_{sw}^{2}} & \frac{1}{{J}_{sw}} \\ 0 & 0\end{matrix} ] [ \text{} \begin{matrix}{θ}_{p} \\ {T}_{f}\end{matrix} ]$$

$${T}_{m} = [ \begin{matrix}{k}_{t} & 0 & 0\end{matrix} ] [ \begin{matrix}{x}_{1} \\ {x}_{2} \\ {T}_{d}\end{matrix} ] + ( - {k}_{t} ) {θ}_{p} + v \qquad ( 9 )$$

wherein x₁=θ_{sw}, and wherein

$${x}_{2} = {\dot{θ}}_{sw} - \frac{{c}_{c}}{{J}_{sw}} {θ}_{p} .$$

It is noted that torque applied by operator 205 appears in expression (8) as a variable of the state vector in the state space notation of expressions (7A) and (7B). It is noted that in expression (8), the first derivative of torque (Ta) applied by operator 205 (i.e., the first derivative of the torque applied by operator 205) represents an assumption made by hypothesizing that torque applied by operator 205 is often zero or other negligible value and increases exclusively during a transient, such as when operator 205 places one or more hands into contact with steering wheel 124. In expression (9) torque applied by operator 205 (T_{d}) can be explicitly modeled via as a state variable utilizing measurements from torque sensor 122 (Tₘ). The constant kₜ, which represents the spring constant of T-bar 235, can be obtained from vehicle parameters memory 332. v of expression (9) can represent noise in output signals from torque sensor 122, which may be minimized via successive estimations of the state vector [x₁, x₂, T_{d}] in optimal filter 335.

Expressions (8) and (9) can be implemented via programming steps executed by computer 104. In an example, programming steps can implement optimal filter 335 in an averaging filter, a Kalman filter, particle filter, etc. For example, implementing expression (8) via a Kalman filter can operate to refine estimates of \dot{T}_{d} and, via integration of \dot{T}_{d} determine an estimated torque applied by operator 205. In a Kalman filter implementation, for example, process noise terms can be represented by ω₁, ω₂, ω₃, and v in expressions (10) and (11), below:

$$( 10 )$$

$$[ \text{} \begin{matrix}{\dot{x}}_{1} \\ {\dot{x}}_{2} \\ {\dot{T}}_{d}\end{matrix} ] = [ \begin{matrix}0 & 1 & 0 \\ - \frac{k}{{J}_{sw}} & - \frac{{c}_{c} + {c}_{sw}}{{J}_{sw}} & \frac{1}{{J}_{sw}} \\ 0 & 0 & 0\end{matrix} ] [ \text{} \begin{matrix}{x}_{1} \\ {x}_{2} \\ {T}_{d}\end{matrix} ] + [ \frac{k - {b}_{θ}}{{J}_{sw}} - \text{} \begin{matrix}\frac{{c}_{c}}{{J}_{sw}} & 0 \\ \frac{{c}_{c} ( {c}_{c} + {c}_{sw} )}{{J}_{sw}^{2}} & \frac{1}{{J}_{sw}} \\ 0 & 0\end{matrix} ] [ \text{} \begin{matrix}{\dot{θ}}_{p} \\ {T}_{f}\end{matrix} ] + [ \begin{matrix}{ω}_{1} \\ {ω}_{2} \\ {ω}_{3}\end{matrix} ]$$

$${T}_{m} = [ \begin{matrix}{k}_{t} & 0 & 0\end{matrix} ] [ \begin{matrix}{x}_{1} \\ {x}_{2} \\ {T}_{d}\end{matrix} ] + ( - {k}_{t} ) {θ}_{p} + v \qquad ( 11 )$$

Thus, via implementation of expressions (10) and (11) in optimal filter 335, estimates of torque applied by operator 205 can be successively estimated in a current measurement frame and refined in future measurement frames by subsequent iterative measurements that reduce process noise represented by ω₁, θ₂, and ω₃ and noise introduced in measurements from torque sensor 122 (v). Accordingly, such refined estimates of the torque contribution from one or more hands of the operator (T_{d}) can be input to hands-on/hands off programming 340, which can be provided to a vehicle assisted driving application. In turn, the vehicle assisted driving application can operate in a mode suitable for vehicle operation while the operator's hands are in contact with the steering wheel. Responsive to receipt of a refined estimate of the torque contribution from one or more hands of the operator (T_{d}) being below a threshold, so as to indicate that the operator of vehicle 102 does not have at least one hand in contact with steering wheel 124, the vehicle assisted driving application can operate in a mode suitable for vehicle operation while the operator's hands are not in contact with the steering wheel. Such operation can include actuating a propulsion component of vehicle 102, providing a visual and/or audible notification to the operator, etc. In some instances, such operation can include transitioning an assisted driving application from an autonomous driving mode to a semi-autonomous driving mode or transitioning from a semi-autonomous driving mode to a manual driving mode.

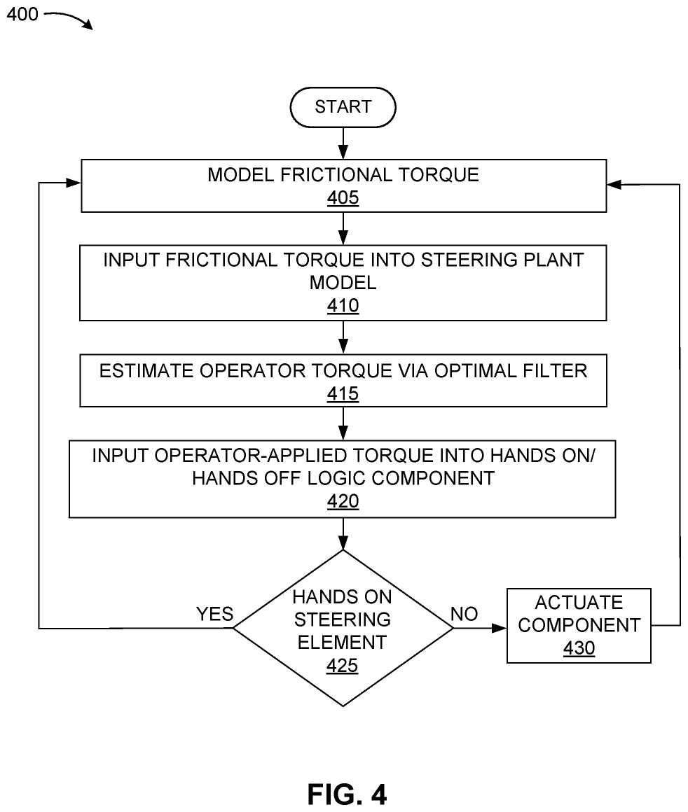

FIG. 4 is a process flow diagram illustrating an example process for estimating operator torque applied to a steering element. Process 400 can operate utilizing programming steps executed by computer 104 in a manner that explicitly models frictional torque (i.e., via friction model 330) from components of steering plant 126. Modeled frictional torque can then be utilized by a model (i.e., steering plant model 325), which utilizes output data from torque sensor 122, steering wheel angle sensor 208, steering wheel angular velocity sensor 209, EPAS motor speed sensor 245, and various parameters obtained from vehicle parameters memory 332.

Process 400 can begin at block 405, which includes, in an initial measurement frame, modeling frictional torque (T_{f}), as described in reference to friction model 330, obtaining EPAS motor speed (cot) from EPAS motor speed sensor 245, vehicle speed (vₓ) and steering angle (S) from sensors 108. Block 405 also includes accessing data from vehicle parameters memory 332, such as k₀⁺, k_{ω}⁺, kᵣ⁺, k₀⁻, k_{ω}⁻, and kᵣ⁻, the front tire side slip angle derived from rear cornering stiffness (α_{f}), tuning factors based on the tires of vehicle 102 (k₁ and k₂), a characteristic calibration value for vehicle 102 (v_{ch}), the wheelbase of vehicle 102 (l), a stiffness parameter (σ₀) of the bristles of the contact surface between the pinion gear and the serrated surface of steering rack 250, and a damping constant (σ₁) of the contact surface between the pinion gear and the serrated surface described in reference to expressions (1)-(5).

Process 400 can continue at block 410, which includes inputting frictional torque modeled at block 405 into steering plant model 325. Inputs to the steering plant model can include parameters obtained from vehicle parameters memory 332, such as the moment of inertia (J_{sw}) of steering wheel 124, the effective stiffness (k) of steering plant 126, the viscous damping coefficient (c_{c}) of steering plant 126, the coefficient of friction (c_{sw}) of steering wheel 124, and the spring constant (kₜ) of T-bar 235. Inputs to the steering plant model can additionally include frictional torque (T_{f}) obtained from block 405, the pinion angle (θₚ) obtained via integration of output signals from EPAS motor speed sensor 245, an output signal representing steering wheel angle (θ_{sw}) obtained from steering wheel angle sensor 208, the steering wheel angular velocity (\dot{θ}_{sw}).

Process 400 can continue at block 415, which includes computing an estimate of operator torque applied to a steering element. Operator torque can be estimated via implementing an optimal filter, such as an averaging filter, a Kalman filter, a particle filter, etc., which includes parameters of friction model 330 and steering plant model 325. Implementing an optimal filter can operate to refine future estimates of torque applied by operator 205 (T_{d}) so as to reduce or minimize noise represented by ω₁, θ₂, and ω₃ and noise introduced in measurements from torque sensor 122 (v).

Process 400 can continue at block 420, which includes inputting refined optimal estimations of torque applied by operator 205 to programming of computer 104 to determine whether torque applied by operator 205 indicates whether the operator has at least one hand in contact with steering wheel 124.

Process 400 can continue at block 425, which includes determining whether refined estimates of torque applied by operator 205 indicates a condition in which operator 205 has at least one hand in contact with steering wheel 124. In response to a determination that operator 205 has applied at least a threshold level of torque to steering wheel 124, process 400 may return to block 405. At block 405, a subsequent measurement frame can begin, which includes modeling frictional torque utilizing updated data from sensors and parameters obtained from vehicle parameters memory 332. In response to a determination that operator 205 does not have at least one hand in contact with steering wheel 124, process 400 proceeds to block 430, which includes actuating a component of vehicle 102, such as reducing propulsion of and/or braking the vehicle 102, generating a message to operator 205, e.g., an audio message or a message via a display screen, etc. Alternatively, or in addition, computer 104 can initiate a haptic output to steering wheel 124 or initiate generation of an audible signal. Process 400 may then return to block 405, at which a subsequent measurement frame can begin.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

The adjectives first and second are used throughout this document as identifiers and, unless explicitly stated otherwise, are not intended to signify importance, order, or quantity.

The term exemplary is used herein in the sense of signifying an example, e.g., a reference to an exemplary widget should be read as simply referring to an example of a widget.

Use of in response to, based on, and upon determining herein indicates a causal relationship, not merely a temporal relationship.

Computer executable instructions may be compiled or interpreted from computer programs created using a variety of programming languages and/or technologies, including, without limitation, and either alone or in combination, Java, C, C++, Visual Basic, Java Script, Perl, Python, HTML, etc. In general, a processor e.g., a microprocessor receives instructions, e.g., from a memory, a computer readable medium, etc., and executes these instructions, thereby performing one or more processes, including one or more of the processes described herein. Such instructions and other data may be stored and transmitted using a variety of computer readable media. A file in a networked device is generally a collection of data stored on a computer readable medium, such as a storage medium, a random access memory, etc. A computer readable medium includes any medium that participates in providing data e.g., instructions, which may be read by a computer. Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

What is claimed is:

1. A system, comprising a computer including a processor and memory, the memory storing instructions executable by the processor to:
compute an estimate of frictional torque responsive to receipt of an input signal representing a measurement of an angular velocity of a steering motor;
compute an estimate of operator torque applied to an element of a steering subsystem based on the computed estimate of the frictional torque; and
actuate a component in a vehicle in response to the computed estimate exceeding a threshold value.

2. The system of claim 1, wherein the threshold value indicates removal of the operator's hand from the steering element.

3. The system of claim 1, wherein the executable instructions further include instructions to:
combine a linearized estimate of frictional torque as a function of the angular velocity of the steering motor with a measure of bristle deflection resulting from contact of a gear of the steering motor with a rack of the steering subsystem.

4. The system of claim 1, wherein the executable instructions further include instructions to:
combine a linearized estimate of frictional torque as a function of the angular velocity of the steering motor with a measure of bristle deflection resulting from contact of a gear of the steering motor with a rack of the steering subsystem and a measure of stiffness and damping of a friction model of a steering subsystem of the vehicle.

5. The system of claim 1, wherein the executable instructions further include instructions to:
combine a linearized estimate of frictional torque as a function of the angular velocity of the steering motor with a measure of bristle deflection resulting from contact of a gear of the steering motor with a rack of the steering subsystem and a measure of stiffness and damping of a LuGre friction model of a steering subsystem of the vehicle.

6. The system of claim 1, wherein the executable instructions to compute the estimate of operator torque include instructions to utilize an optimal filter.

7. The system of claim 1, wherein the executable instructions to compute the estimate of operator torque include instructions to utilize a Kalman filter or a particle filter.

8. The system of claim 1, wherein the component is a component of a human machine interface (HMI) of the vehicle.

9. The system of claim 1, wherein the instructions to actuate the component of the vehicle include instructions to transition an assisted driving application from an autonomous driving mode to a semi-autonomous driving mode or from a semi-autonomous driving mode to a manual driving mode.

10. The system of claim 1, further comprising:
a torque sensor to provide a measure of the operator torque applied to the steering element, the torque sensor located proximate to an interface between a rack and a pinion gear of a steering subsystem.

11. A method comprising:
computing an estimate of frictional torque responsive to measuring an angular velocity of a steering motor;
computing an estimate of operator torque applied to an element of a steering subsystem based on the computed estimate of the frictional torque; and
actuating a component in a vehicle in response to the computed estimate exceeding a threshold value.

12. The method of claim 11, wherein the threshold value indicates removal of the operator's hand from the steering element.

13. The method of claim 11, further comprising:
combining a linearized estimate of frictional torque as a function of the angular velocity of the steering motor with a measure of bristle deflection resulting from contact of a gear of the steering motor with a rack of the steering subsystem.

14. The method of claim 11, further comprising:
combining a linearized estimate of frictional torque as a function of the angular velocity of the steering motor with a measure of bristle deflection resulting from contact of a gear of the steering motor with a rack of the steering subsystem and a measure of stiffness and damping of a friction model of a steering subsystem of the vehicle.

15. The method of claim 11, further comprising:
combining a linearized estimate of frictional torque as a function of the angular velocity of the steering motor with a measure of bristle deflection resulting from contact of a gear of the steering motor with a rack of the steering subsystem and a measure of stiffness and damping of a LuGre friction model of a steering subsystem of the vehicle.

16. The method of claim 11, wherein computing the estimate of operator torque further comprises:
computing the estimate of the operator torque utilizing an optimal filter.

17. The method of claim 11, wherein computing the estimate of operator torque further comprises:
computing the estimate of the operator torque utilizing a Kalman filter or a particle filter.

18. The method of claim 11, wherein the component is a component of a human machine interface (HMI) of the vehicle.

19. The method of claim 11, wherein actuating a component of the vehicle includes transitioning an assisted driving application from an autonomous driving mode to a semi-autonomous driving mode or from a semi-autonomous driving mode to a manual driving mode.

20. The method of claim 11, further comprising:
receiving a signal from a torque sensor representing a measure of the operator torque applied to the steering element, the torque sensor located proximate to an interface between a rack and a pinion gear of a steering subsystem.
